(19) United States
(12) Patent Application Publication
(10) Pub. No.: US 2006/0049273 A1
(43) Pub. Date: Mar. 9, 2006

(54) Flush cap with shut-off for sprinker head

(76) Inventor: Richard Zhang, Boca Raton, FL (US)

Correspondence Address: OSTROLENK FABER GERB & SOFFEN, 1180 AVENUE OF THE AMERICAS, NEW YORK, NY, 100368403, US

(21) Appl. No.: 11/123,411

(22) Filed: May 6, 2005

Related U.S. Application Data
(60) Provisional application No. 60/568,316, filed on May 6, 2004.

(51) Int. Cl. B05B 15/02

(52) U.S. Cl. 239/106; 239/203

(57) ABSTRACT

A flush cap assembly for a sprinkler head in an irrigation system comprising an array of sprinkler heads, the flush cap having a body portion adapted to be removably attached to a sprinkler head, an opening in the body portion communicating with a fluid flow path in the sprinkler head through which water can exit the sprinkler head during flushing of the irrigation system, and a cover portion which is manually movable to cover and uncover the opening in the body portion to selectively prevent water from exiting a particular sprinkler head during flushing of the irrigation system. Also disclosed is a method of preparing an irrigation system for use in which flush cap assemblies as described are employed. The cover portion may be rotatable or otherwise operable, and may include an opening which is alignable with the body opening to permit water to exit during flushing.

### CROSS-REFERENCE TO RELATED APPLICATIONS

This application is based on and claims priority to U.S. Provisional Application 60/568,316, filed May 6, 2004, the entire disclosure of which is incorporated herein by reference.

### BACKGROUND OF THE INVENTION

1. Technical Field of the Invention

This invention relates generally to underground irrigation systems that include a plurality of pop-up-type sprinklers connected to an irrigation source pipeline, and more particularly, to shipping or flush caps for such sprinklers.

2. Related Art

Manufacturers of turf irrigation systems often supply the sprinklers with flush caps to cover the opening of the spray heads instead of a nozzle which will be used for normal operation. During installation, a shallow trench is dug in the desired layout, and the network of irrigation supply piping is laid out in the trench. The spray heads are then attached to the piping with the caps still attached, the water supply is connected, and the trench is covered over.

Once this has been done, the piping and spray heads must be flushed before the spray nozzles are installed to remove dirt and debris which accumulated in the system during installation, or the spray nozzles may become unobstructed when the system is placed in operation. This is accomplished by turning on the irrigation system and allowing a high pressure, high velocity flow through the system to “blow out” the dirt and debris, generally through side openings provided in the flush caps. In this flushing process, all of the spray heads along the irrigation path are essentially “blown out” at the same time (once the water flow reaches each respective sprinkler head), and then are closed at the same time, when the water supply is turned off.

Conventional flush caps include some type of mechanism which closes the spray head outlet opening when the water is turned off to prevent debris from reentering the spray head. After the pipes and spray heads have been flushed in a conventional sprinkler system, and the irrigation source has been turned off, the flush caps are removed from the spray heads in preparation for installation of the nozzles. When the spray heads are mounted on risers which are lifted by water pressure during operation, the conventional flush caps are typically equipped with a lift ring or other gripping means to facilitate lifting the riser.

To a greater or lesser degree, conventional flush caps suffer from certain disadvantages. For one thing, it is difficult to reliably seal the flush openings after the flushing process is completed. As a result, there is a risk of debris re-entering the spray heads, particularly, since the flush water usually pools around the spray heads. Providing a reliable closure often entails increased cost and complexity in an item which is generally not reusable.

Another problem is that conventional flush caps lack a way to selectively close an individual flush cap at a particular location in the system when further flushing of the spray head at that location is not needed, but other spray heads require further flushing. This results in unnecessary flooding around the spray heads which are already cleared, and prevents direction of extra water to the spray heads which do require further cleaning.

Thus a need clearly exists for further improvement in what, on its face, would seem to be a relatively simple, but widely used device.

### SUMMARY OF THE INVENTION

The present invention seeks to satisfy this need by providing a flush cap assembly which includes a mechanism to shut off the water to individual spray heads and to reliably prevent backflow of debris through the shut off flush cap, as well as a method of preparing a sprinkler system for operation using such a flush cap assembly.

The device is comprised of a body portion which is constructed for removable attachment to the spray head, and a cap rotatably mounted on the body portion to open and close a flow passage through which the spray head and piping can be flushed of dirt and debris. The method of use involves providing each of the spray heads with a flush cap assembly as described above, installing the system, opening the flow passages for all the spray heads, turning on the water supply, selectively closing individual flush caps for portions of the system which have been sufficiently flushed, thereby directing additional water to portions of the system still requiring it, thereafter shutting down the system, and replacing the flush caps with spray nozzles.

Flush caps according to the invention provide improved functionality without adding significant cost, and the associated method permits more efficient, and, in some instances, faster preparation of the system for use.

The invention has several specific advantages over conventional flush caps. First, the shut off mechanism according to the invention allows the installer to shut off each spray head after sufficient water has flowed through that respective spray head. By enabling the installer to selectively stop the water flow through individual spray heads, further flushing of other spray heads can continue to be flushed without further flooding around the spray heads that have been shut off.

A second advantage provided by the invention is that when the installer shuts off selected spray heads, water flow to the other spray heads increases, which results in an increased flow rate of water through the other spray heads to thereby flush the system more effectively.

### BRIEF DESCRIPTION OF THE DRAWING(S)

FIG. 1A is a perspective drawing showing the overall appearance of a first embodiment of the flush cap assembly according to the invention.

FIG. 1B is a perspective drawing showing the cap portion of the flush cap assembly of FIG. 1A.

FIG. 1CB is a perspective drawing showing the body portion of the flush cap assembly of FIG. 1A.

FIG. 2 is a top plan view of the device shown in FIG. 1A-1C with the flushing flow path open.

FIG. 3 is a sectional view taken vertically along line 3-3 in FIG. 2.

FIG. 4 is a side elevation of the device shown in FIGS. 1-3 with the flushing flow path open.

FIG. 5 is a cross-sectional view taken along line 5-5 in FIG. 4, looking downward

FIG. 6 is a cross-sectional view taken along line 6-6 in FIG. 4, looking upward.

FIG. 7 is a top plan view of the device shown in FIG. 1 with the flushing flow path closed.

FIG. 8 is a sectional view taken vertically along line 3-3 in FIG. 7.

FIG. 9 is a side elevation of the device shown in FIGS. 1-3 with the flushing flow path open.

FIG. 10 is a cross-sectional view taken along line 10-10 in FIG. 9, showing the flushing flow path closed.

FIG. 11 is a perspective drawing showing the overall appearance of a second embodiment of the flush cap assembly according to the invention in the open position.

FIG. 12 is a perspective view showing the overall appearance of a second embodiment in the closed position.

FIG. 13 is a perspective view seen from below showing the construction of the cap portion of the second embodiment.

FIG. 14 is a perspective view seen from above showing the construction of the body portion of the second embodiment.

### DETAILED DESCRIPTION OF PREFERRED EMBODIMENTS OF THE INVENTION

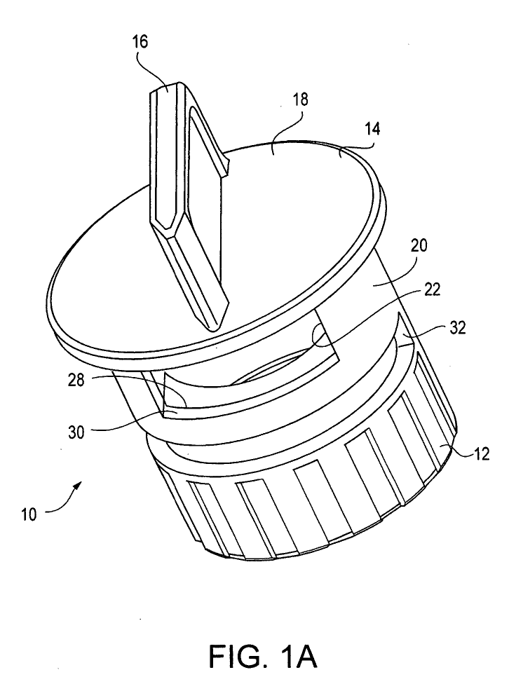

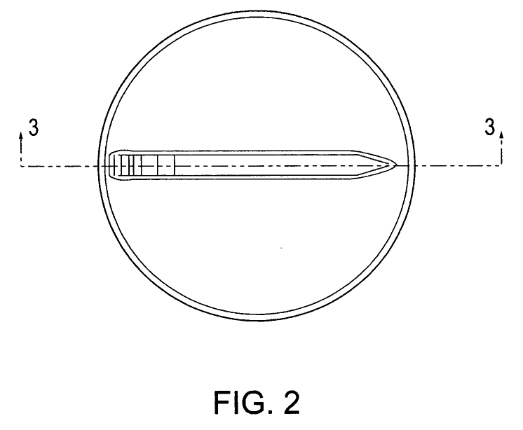

Referring first to FIGS. 1-3, a first embodiment of a flush cap assembly in accordance with the present invention, generally denoted at 10, comprises a body 12 and a cap 14 fitted over the top portion of body 12, and rotatably mounted thereon, as described more fully below. Cap 14 includes a top plate 18, a handle 16 extending upwardly from top plate 18, a sleeve 20 downwardly depending from top plate 18, and a circumferentially extending opening 22 in sleeve 20.

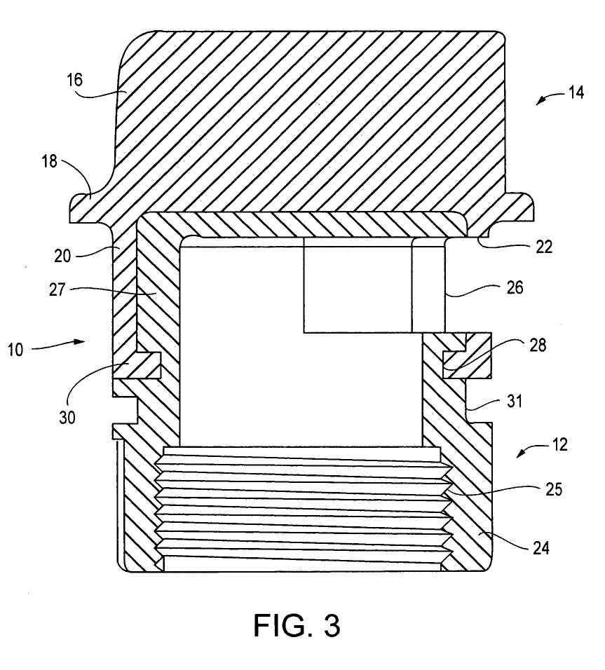

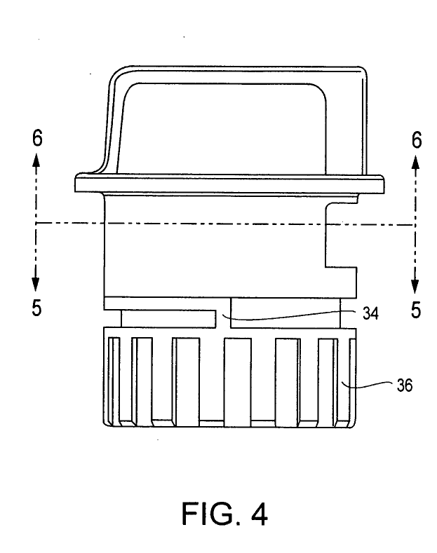

As best seen in FIGS. 1C and 3, body 12 includes a bottom portion 24 which is internally threaded at 25 for securing the flush cap assembly onto a spray head. If desired, the exterior surface of bottom portion 24 may be provided with a textured gripping surface, as by vertical ribs 36 (see FIGS. 1A, 1B, and 4) to facilitate installation and removal of the assembly 10 from the spray head.

Body 12 also includes an upper portion 27 having a circumferentially extending opening 26 adapted to be aligned with opening 22 in cap 14 to allow water to exit from the spray head during the flushing operation. As described below, cap 14 is rotatable between such an aligned open position, and a closed position in which sleeve 20 blocks opening 26 to prevent water flow out of the spray head. A circumferential groove 28 encircling the body 12 engages with a retaining flange 30 extending radially inward from the bottom of sleeve 20 to guide the rotation of cap 14 relative to body 12, and to prevent cap 14 from being separated from body 12 by the force of the water during the flushing operation, but any other suitable or desired retaining means may be employed instead.

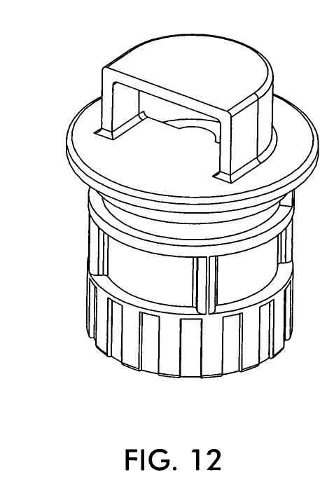

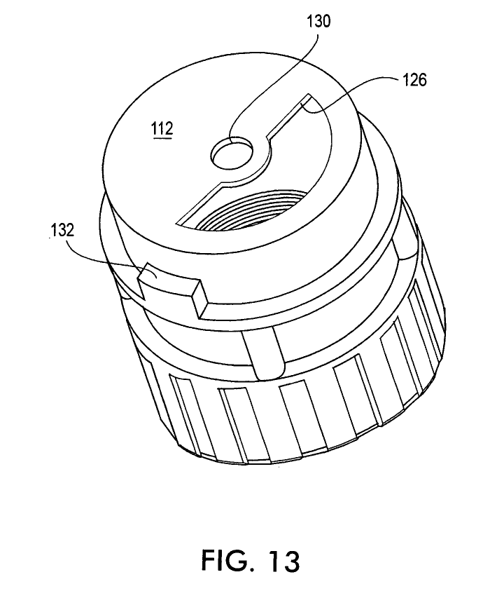

Axially below groove 28 is a stepped shoulder 31 extending part way around body 12. One end of shoulder 31 is delimited by a rotational limit stop 34 best seen in FIGS. 4 and 12. When cap 14 is in place on body 12, a rotation limiting shoulder 32 formed as an extension of the sleeve 20 rides on shoulder 31 and engages limit stop 34 at a rotational position for which openings 22 and 26 are 180 degrees out of alignment corresponding to a closed position of cap assembly 10, as described below. Again, however, any other suitable or desired rotation limiting means may be employed instead.

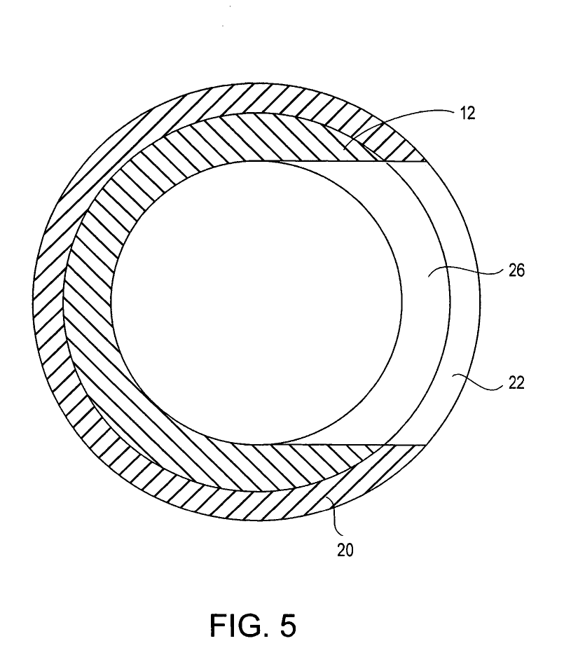

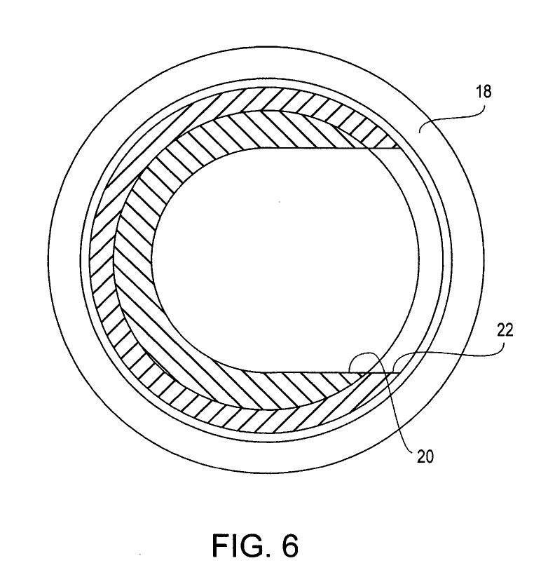

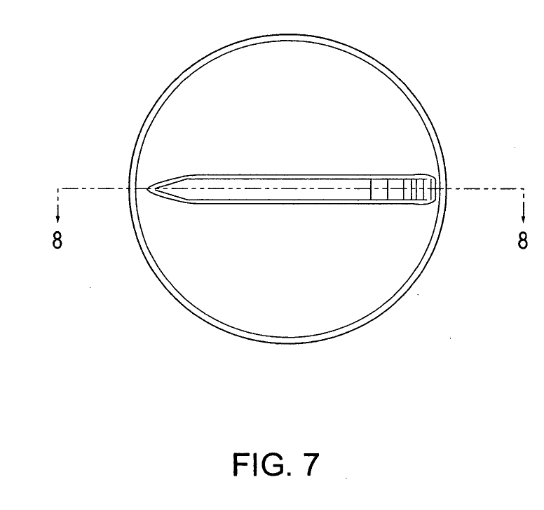

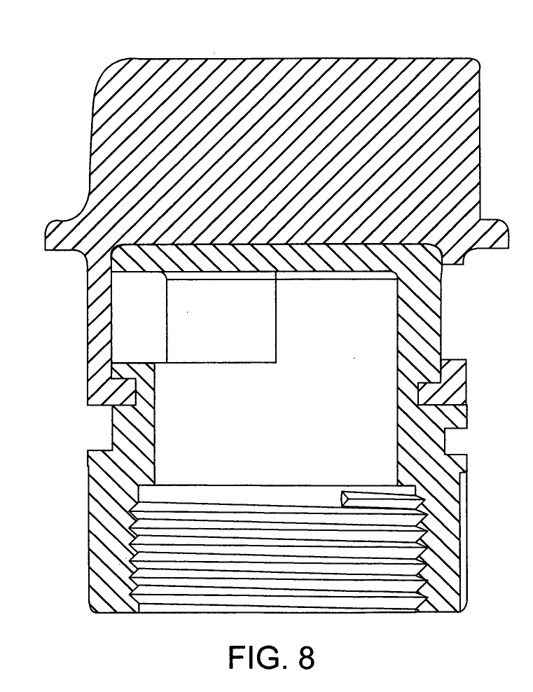

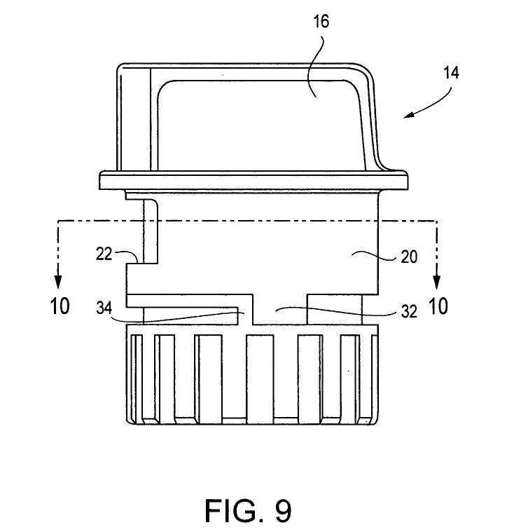

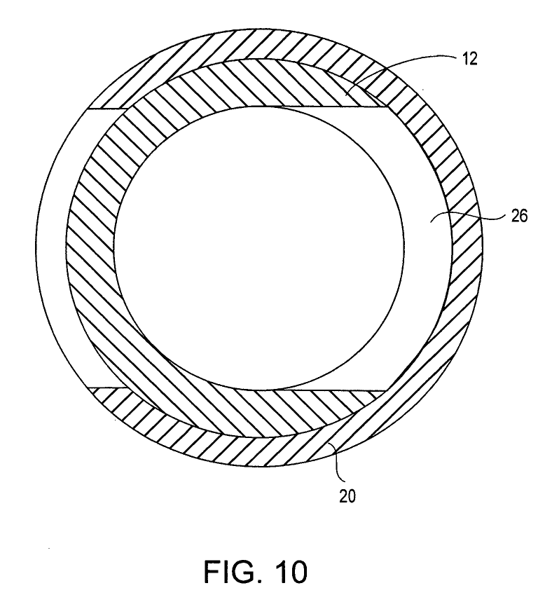

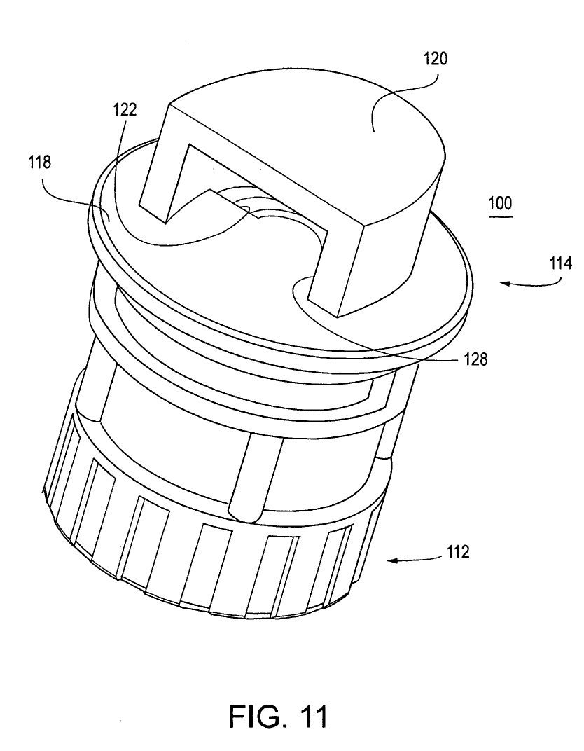

As best seen in FIGS. 1, 3, and 5-6, when cap 14 is in the open position, opening 22 is aligned with the opening 26 in body 12, thus allowing a water stream to exit the spray head. When it is desired to close a particular flush cap assembly, cap portion 14 can rotated to a closed position, as shown in FIGS. 8-10, until rotation limiting shoulder 32 abuts limit stop 34 (see FIG. 9), whereby the opening 22 of the cap 14 is completely out of alignment with the opening 26 of the body 12. In this position, the opening of the body 12 is closed off by the sleeve 20 of the cap 14, as can be seen in FIG. 10.

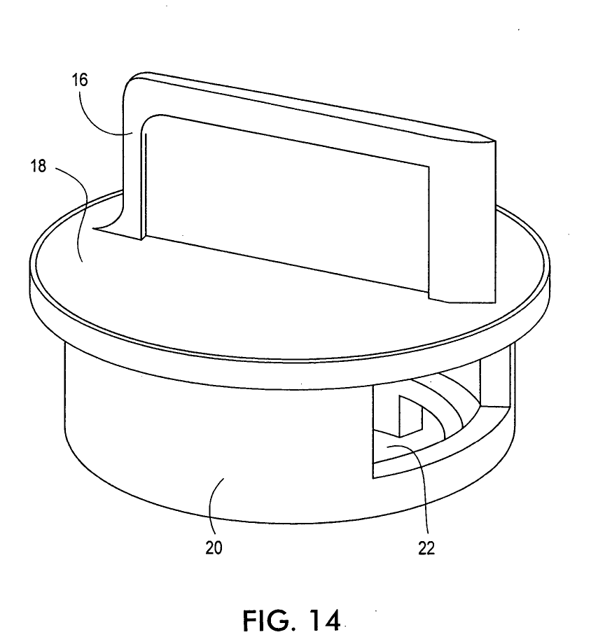

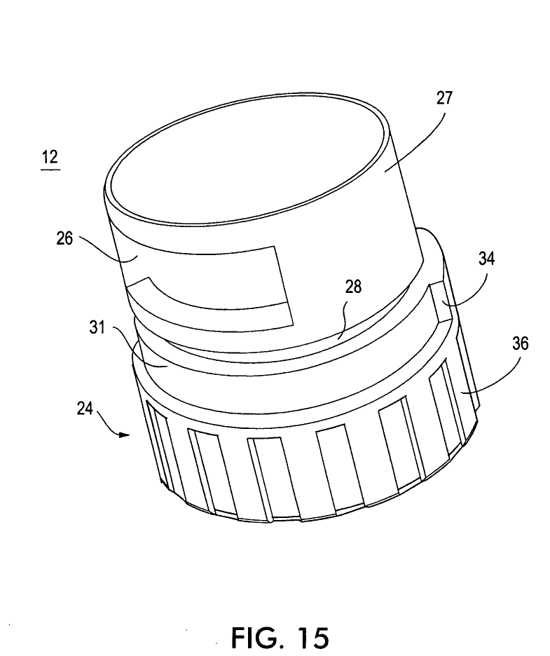

A second embodiment of the invention is shown in FIGS. 11-14, generally denoted at 100. This includes a body portion 112, and a cap portion 114 as in the first embodiment. An opening 126 is formed through the top surface 111 of body portion 112 (see FIG. 14) substantially in the shape of a semicircle. Cap portion 114 includes a base plate 118, a substantially semicircular opening 122 formed in the base plate 118, and a deflector 120 which also serves as the gripping element for the assembly 100. The deflector 120 is a substantially enclosed structure located on the base plate 118 and over the opening 122, but has an opening 128 on one side thereof opposite to opening 122.

Body portion 112 and cap portion 114 may be secured together, for example, by a downwardly depending central pin having a barbed lower end (not shown) adapted to be snap fitted into a central opening 130 in the top of body portion 112. Alternatively, a slot and rib arrangement as shown and described in connection with the first embodiment, or any other suitable or desired arrangement, can be employed.

As best seen in FIGS. 13 and 14, rotation of cap portion 114 relative to body portion 112 is limited by an upwardly projecting stop member 132 on body portion 112 which engages with a downwardly depending limit ring 134 on the under side of cap portion 114.

When the opening 126 of the cap 114 is aligned with the opening 126 of body portion 112 as shown in FIG. 11, water exiting the spray head through the opening 126 will be deflected by the interior surface of the deflector 120 to flow out to the side of the flush cap assembly 100. When the openings 126 and 122 are completely out of alignment as shown in FIG. 12, the water flow is prevented from exiting the spray head by the base plate 118 covering the opening 122. To rotate the cap 114, the installer can simply grasp the deflector unit 120.

In another embodiment of the invention, the flush cap shut-off feature may be provided as a flap or a slider which can be manually locked or released with respect to an opening on the body. In that event, the cap and body portions do not need to be movable relative to each other. Other mechanisms for blocking the outlet opening of the body may be implemented within the principles and scope of the present invention, as will be appreciated by those skilled in the art.

While the invention has been described and illustrated with reference to specific exemplary embodiments, it should be understood that many other modifications and substitutions could be made without departing from the spirit and scope of the invention. Accordingly, the invention is not to be considered as limited by the foregoing description, but is to be given the full scope permitted by the appended claims.

I claim:

1. A flush cap assembly for a sprinkler head in an irrigation system comprising an array of sprinkler heads, each including a flush cap assembly, the flush cap assembly comprising:
a body portion adapted to be removably attached to a sprinkler head;
an opening in the body portion communicating with a fluid flow path in the sprinkler head through which water can exit the sprinkler head during flushing of the irrigation system; and
a movable member manually operable to cover and uncover the opening in the body portion to selectively prevent water from exiting the sprinkler head during flushing of the irrigation system.

2. A flush cap assembly according to claim 1, wherein the movable member comprises a cap portion adapted to fit over the body portion, the cap portion being manually movable between first and second positions relative to the body portion, and including a portion configured to uncover and cover the opening in the body portion when the cap portion is moved between the first and second positions, respectively.

3. A flush cap assembly according to claim 2, wherein the cap portion includes an opening configured to be aligned with the opening in the body portion when the cap portion is in the first position to allow water to exit the sprinkler head during flushing of the irrigation system.

4. A flush cap assembly according to claim 2, wherein the cap portion is rotatable relative to the body portion between the first and second positions, and includes an opening configured to be aligned with the opening in the body portion to allow water to exit the sprinkler head during flushing of the irrigation system when the cap portion is in the first position, and to be out of alignment with the opening in the body portion to prevent water from exiting the sprinkler head when the cap portion is in the second position.

5. A flush cap assembly according to claim 4, wherein the second position of the cap portion is defined by a first member on the cap portion which engages with a second member on the body portion at a rotational position for which the respective openings in the cap and body portions are sufficiently out of alignment to prevent water from exiting the sprinkler head.

6. A flush cap assembly according to claim 4, wherein the second position of the cap portion is defined by a first member on the cap portion which engages with a second member on the body portion at a rotational position for which the respective openings in the cap and body portions are 180 degrees out of alignment.

7. A flush cap assembly according to claim 2, wherein the cap portion includes an opening configured to be aligned with the opening in the body portion to allow water to exit the sprinkler head during flushing of the irrigation system when the cap portion is in the first position;
the openings in the body and cap portions are oriented in parallel planes perpendicular to an axial flow path through the sprinkler head; and
the cap portion includes a deflector member in the path of a water stream exiting through the aligned openings and oriented to direct the exiting water stream sideways relative to the sprinkler head.

8. A flush cap assembly according to claim 2, wherein the deflector member includes a portion adapted to be grasped by the fingers to permit the cap to be moved between the first and second positions.

9. A flush cap assembly according to claim 2, wherein the cap portion includes an opening configured to be aligned with the opening in the body portion to allow a water stream to exit the sprinkler head during flushing of the irrigation system when the cap is in the first position, the openings in the body and cap portions being so oriented that the water stream exits sideways relative to the sprinkler head.

10. A flush cap assembly according to claim 9, wherein the cap portion includes a handle portion adapted to be grasped by the fingers to permit the cap to be moved between the first and second positions.

11. A flush cap assembly according to claim 2, further including a recess in one of the cap and body portions, and a complementary projection on the other of the cap and body portions, the projection and the recess being positioned and configured to engage with each other to retain the cap portion on the body portion.

12. A flush cap assembly according to claim 11, wherein:
the cap portion is rotatable relative to the body portion;
the recess is an arcuate slot is located on an outer surface of the body portion;
the complementary projection is an arcuate flange on an inner surface of the cap portion; and
the flange is positioned and configured to engage with and ride in the slot as the cap rotates relative to the body portion.

13. A flush cap assembly according to claim 4, wherein the second position of the cap portion is defined by a rotational limit stop on the body portion which engages with a rotational limit stop on the cap portion at a rotational position for which the respective openings in the cap and body portions are sufficiently out of alignment to prevent water from exiting the sprinkler head.

14. A flush cap assembly according to claim 4, further including:
a first shoulder stepped radially inwardly and extending circumferentially part way around an outer surface the body portion, one end of the shoulder being delimited by a rotational limit stop; and
a rotation limiting second shoulder extending radially from an inner surface of the cap portion which rides on the first shoulder and engages the limit stop at a rotational position for which the openings in the cap and body portions are sufficiently out of alignment to prevent water flow from the sprinkler head.

15. An irrigation system including a plurality of sprinkler heads, each of the sprinkler heads being fitted with a flush cap assembly according to claim 1.

16. An irrigation system according to claim 15, wherein:
the respective movable members of the flush cap assemblies each comprise a cap portion adapted to fit over the body portion, and to be retained thereon, the cap portion being manually rotatable between first and second positions relative to the body portion, wherein the cap portion includes:
an opening configured to be aligned with the opening in the body portion when the cap portion is in the first position to allow water to exit the sprinkler head during flushing of the irrigation system; and
a portion configured to cover the opening in the body portion when the cap portion is in the second position.

17. An irrigation system according to claim 16, wherein the second position of the cap portion is defined by a first member on the cap portion which engages with a second member on the body portion at a rotational position for which the respective openings in the cap and body portions are sufficiently out of alignment to prevent water from exiting the sprinkler head.

18. An irrigation system according to claim 16, wherein:
the openings in the body and cap portions are oriented in parallel planes perpendicular to an axial flow path through the sprinkler head; and
the cap portion includes a deflector member in the path of a water stream exiting through the aligned openings and oriented to direct the exiting water stream sideways relative to the sprinkler head.

19. An irrigation system according to claim 16, wherein the openings in the body and cap portions are so oriented that the water stream exits sideways relative to the sprinkler head.

20. A method of preparing an irrigation system for use, the system including a plurality of sprinkler heads, the method comprising the steps of:
fitting each of the sprinkler heads with a removable flush cap assembly, each flush cap assembly including:
a body portion adapted to be removably attached to the sprinkler head;
an opening in the body portion communicating with a fluid flow path in the sprinkler head through which water can exit the sprinkler head; and
a movable member manually operable to cover and uncover the opening in the body portion;
installing a network of piping and connecting it to a source of water;
attaching the sprinkler heads to the network of piping with the flush cap assemblies attached thereto;
opening the flow passages for all the flush cap assemblies;
turning on the source of water to flush dirt and debris from the piping and the sprinkler heads;
selectively closing individual flush caps for portions of the system which have been sufficiently flushed, thereby directing additional water to portions of the system still requiring flushing;
thereafter shutting down the water supply; and
replacing the flush caps with spray nozzles.
